(19) United States
(12) Patent Application Publication
(10) Pub. No.: US 2024/0061277 A1
(43) Pub. Date: Feb. 22, 2024

(54) GLASSES

(71) Applicant: Greatland Enterprise Co., Ltd., Changhua County (TW)

(72) Inventors: Shu-Hsi HSU, Changhua County (TW); Yi-Jhen CHEN, Changhua County (TW)

(21) Appl. No.: 17/888,958

(22) Filed: Aug. 16, 2022

(51) Int. Cl. G02C 11/00; G02C 1/00

(52) U.S. Cl. CPC G02C 11/12; G02C 1/10; G02C 2200/02

(57) ABSTRACT

A pair of glasses is provided, including a frame and at least one first magnetic member. The frame includes an inner surface and an outer surface opposite to each other, and the inner surface has at least one first receiving groove disposed thereon and includes at least one projection located within the at least one first receiving groove. The at least one first magnetic member is configured to be attached with at least one second magnetic member by a magnetic attractive force. The at least one first magnetic member includes at least one recession disposed thereon. The at least one first magnetic member is received within the at least one first receiving groove and the at least one projection is received within the at least one recession.

### BACKGROUND OF THE INVENTION

### Field of the Invention

The present invention relates to a pair of glasses.

### Description of the Prior Art

With the popularity of electronics, such as smart phones, computers or tablets, people's eyes may be damaged due to looking at digital screens for long hours. Therefore, glasses are widely used to improve user's vision or reduce eyestrain, such as nearsighted glasses, farsighted glasses, or reading glasses. To reduce eye problems caused by sun damage, sunglasses are also available to shield sun light.

Furthermore, an accessory may be detachably assembled to a frame of a pair of glasses to meet different requirements. For example, windproof shields are provided to prevent eyes from dust and wind (especially for people with the dry eye); and a sub-frame is provided to block the sun. Generally, the accessory is detachably assembled to the frame by clipping, engagement or magnetic attraction. For example, a magnetic member 100 is fixedly embedded within a concave portion 201 of a frame 200 by adhesives, as shown in FIG. 10. However, when the frame 200 is deformed due to lenses assembling or daily use and a shape of the concave portion 201 is changed, as shown in FIG. 11, the magnetic member 100 is easy to be detached unexpectedly from the concave portion 201, as shown in FIG. 12.

The present invention is, therefore, arisen to obviate or at least mitigate the above-mentioned disadvantages.

### SUMMARY OF THE INVENTION

The main object of the present invention is to provide a pair of glasses whose at least one component for detachably assembling with an accessory is stably mounted thereon, which is durable to use and convenient to be assembled.

To achieve the above and other objects, the present invention provides a pair of glasses, including: a frame and at least one first magnetic member. The frame includes an inner surface and an outer surface opposite to each other, and the inner surface has at least one first receiving groove disposed thereon and includes at least one projection located within the at least one first receiving groove. The at least one first magnetic member is configured to be attached with at least one second magnetic member by a magnetic attractive force. The at least one first magnetic member includes at least one recession disposed thereon. The at least one first magnetic member is received within the at least one first receiving groove and the at least one projection is received within the at least one recession.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a breakdown drawing of a preferable embodiment of the present invention as viewed in another direction;

FIG. 4 is a partial enlargement of FIG. 3;

FIG. 5 is a partial enlargement according to a preferable embodiment of the present invention;

FIG. 6 is a top view of a preferable embodiment of the present invention when two temples are folded relative to a frame;

FIG. 7 is a partial cross-sectional enlargement of a preferable embodiment of the present invention;

FIG. 8 is a schematic diagram showing deformation of a first receiving groove according to a preferable embodiment of the present invention

FIG. 9 is a partial cross-sectional view of another preferable embodiment of the present invention;

FIG. 10 is a schematic diagram showing a groove receiving a magnetic member therewithin according to a prior art; and

FIGS. 11 and 12 are schematic diagrams showing deformation of the groove according to the prior art.

### DETAILED DESCRIPTION OF THE PREFERRED EMBODIMENTS

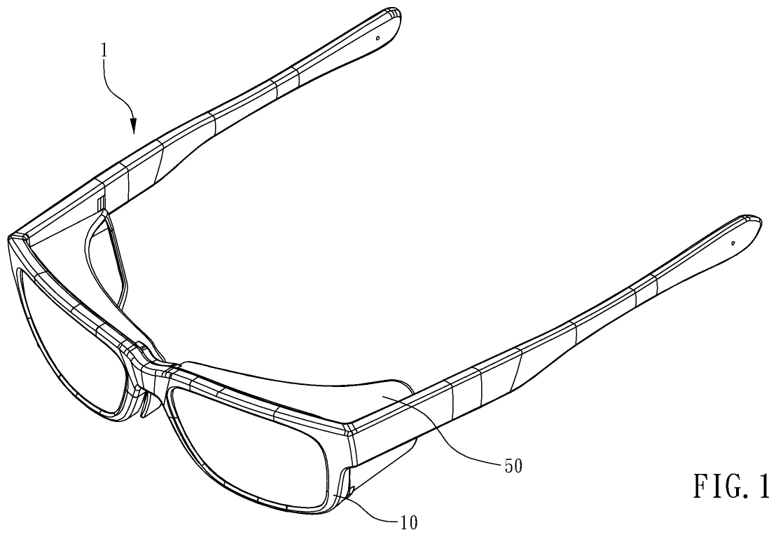

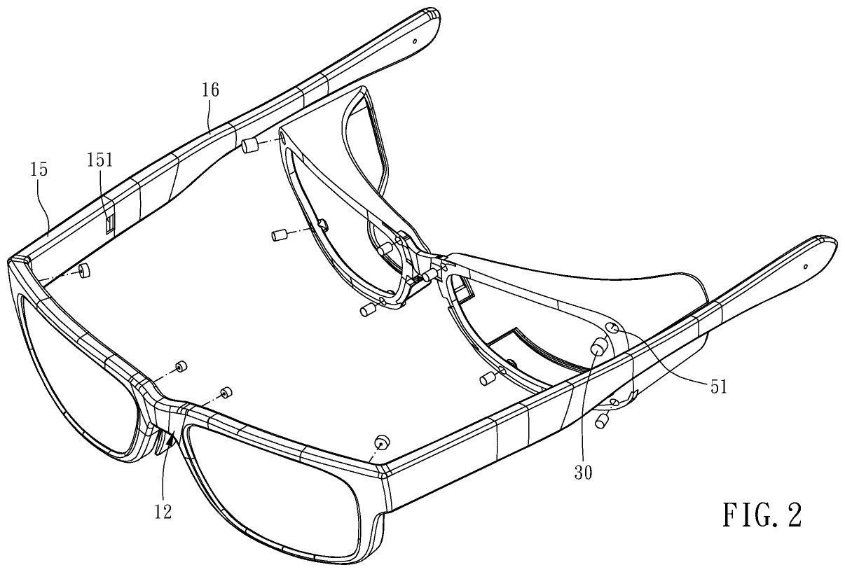

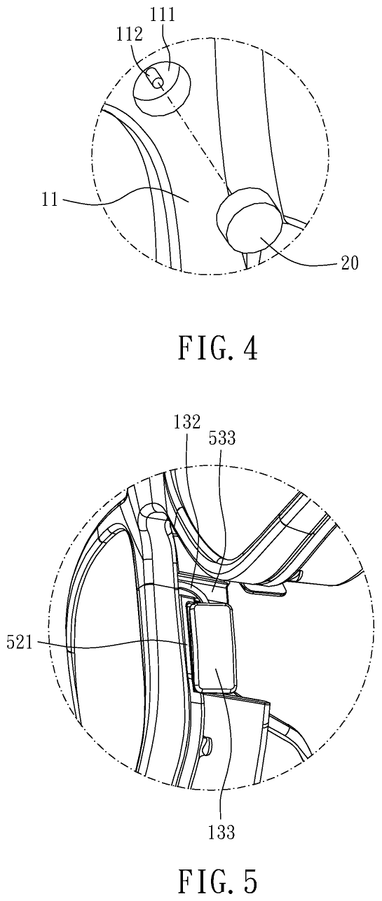

Please refer to FIGS. 1 to 8 for a preferable embodiment of the present invention. A pair of glasses 1 of the present invention includes a frame 10 and at least one first magnetic member 20.

The frame 10 includes an inner surface 11 and an outer surface 12 opposite to each other, and the inner surface 11 has at least one first receiving groove 111 disposed thereon and includes at least one projection 112 located within the at least one first receiving groove 111. The at least one first magnetic member 20 is configured to be attached with at least one second magnetic member 30 by a magnetic attractive force. The at least one first magnetic member 20 includes at least one recession 21 disposed thereon, and the at least one first magnetic member 20 is received within the at least one first receiving groove 111 and the at least one projection 112 is received within the at least one recession 21. Therefore, the at least one first magnetic member 20 is stably mounted within the at least one first receiving groove 111 and radially restricted by the at least one projection 112. When the at least one first magnetic member 20 has no adhesion with a groove wall of the at least one first receiving groove 111, the at least one projection 112 and the at least one recession 21 prevent the at least one first magnetic member 20 from being directly detached from the frame 10.

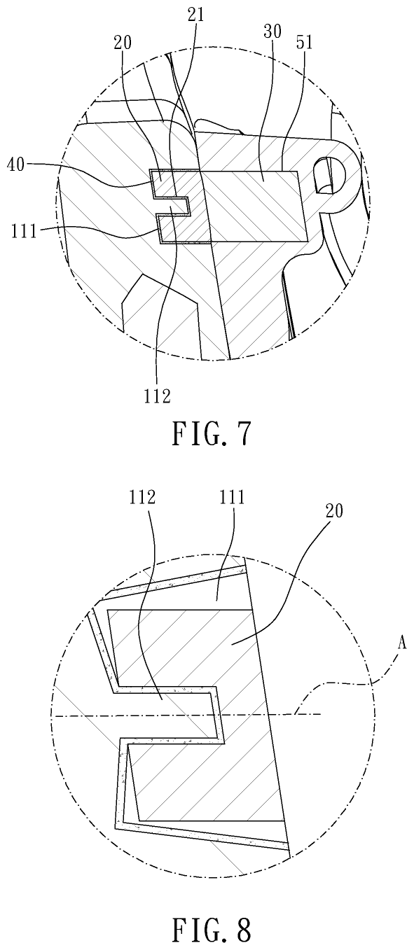

Preferably, each said first magnetic member 20 and a groove wall of one said first receiving groove 111 have an adhesive material 40 disposed therebetween, and a portion of the adhesive material 40 is disposed between one said first magnetic member 20 and one said projection 112 so as to stably connect each said first magnetic member 20 with the groove wall of one said first receiving groove 111 and one said projection 112, as shown in FIG. 7. In other embodiments, each said first magnetic member may be tightly fit into one said first receiving groove and engaged with one said projection via one said recession in tight fit, which allows the at least one first magnetic member to be assembled within the at least one first receiving groove without the adhesive material.

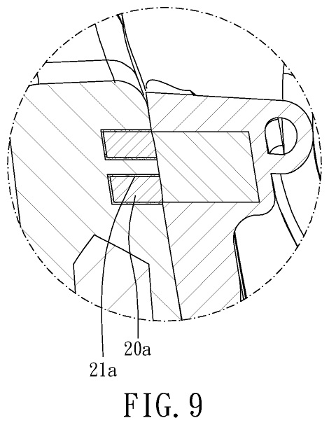

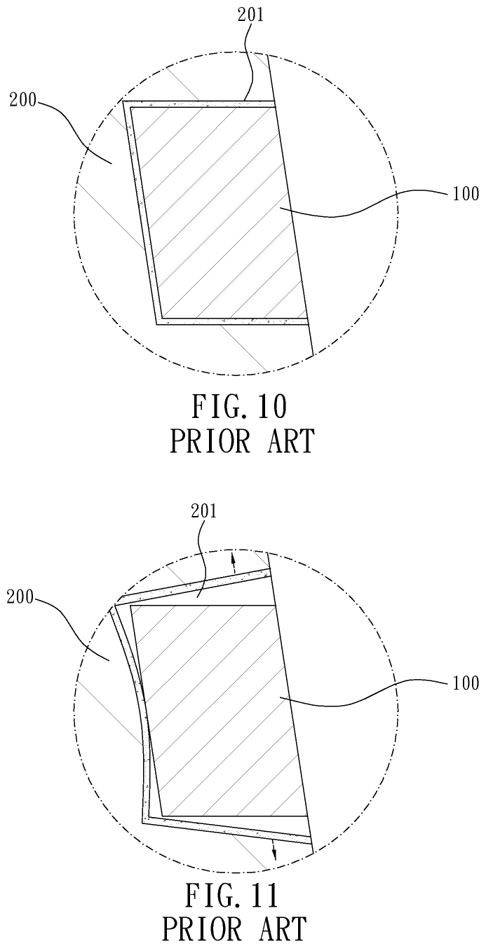

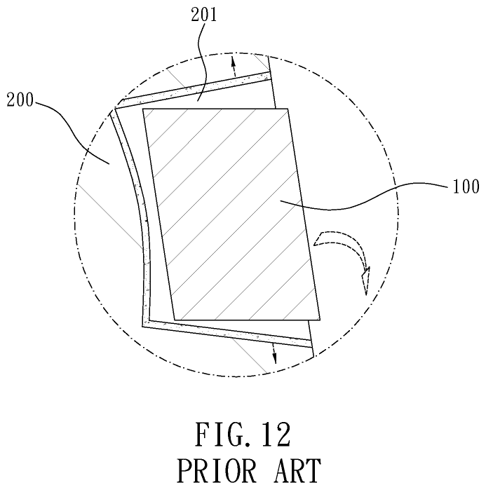

In this embodiment, each said first receiving groove 111 is a circular groove, and each said projection 112 is a column extending along a central axis A of one said first receiving groove 111; each said recession 21 is a blind hole extending in a thickness direction of one said first magnetic member 20. In other embodiments, each said first receiving groove may be triangular, rectangular, oval, or any other shapes. When the frame 10 is bent and a shape of one said first receiving groove 111 is changed, the projection 112 disposed within the said first receiving groove 111 can be stably connected with one said first magnetic member 20 since the said first receiving groove 111 has less deformation near the central axis A, as shown in FIG. 8. Specifically, in a depth direction of the at least one first receiving groove 111, each said projection 112 protrudes from a bottom wall of one said first receiving groove 111 along the depth direction. Therefore, the portion of each said projection 112 received in one said recession 21 can effectively interfere radially with one said first magnetic member 20. In other embodiments, each said recession 21a may be a through hole penetrating through one said first magnetic member 20a, as shown in FIG. 9, which provides good assembling stability and easy processing.

The frame 10 further includes at least one eye rim 13 configured to be assembled with at least one lens, the at least one eye rim 13 has a plurality of said first receiving grooves 111 and a plurality of said first magnetic members 20 disposed thereon, and the plurality of said first receiving grooves 111 are spaced apart from one another and circumferentially arranged. In this embodiment, the frame 10 is integrally made from a plastic material by injection molded so as to have good structural strength; the frame 10 further includes two said eye rims 13, a nose bridge 14 connected between the two said eye rims 13 and two connecting portions configured to be assembled with two temples 16. A diametrical dimension of one of said first magnetic members 20 adjacent to one of the two connecting portions 15 is larger than a diametrical dimension of one of said first magnetic members 20 adjacent to the nose bridge 14 so as to provide sufficient magnetic attraction force with the at least one second magnetic member 30, and less influence on a structural strength of the frame 10. However, the frame may be made of metal, carbon fiber or plastic stock by other manufacturing methods, such as CNC cutting.

The pair of glasses 1 further includes an eye cup 50 detachably connected to the inner surface 11 so as to provide windproof effect. The eye cup 50 has the at least one second magnetic member 30 disposed thereon, and a number of the at least one second magnetic member 30 corresponds to a number of the at least one first magnetic member 20. In this embodiment, the eye cup 50 includes at least one second receiving groove 51 received the at least one second magnetic member 30 therewithin; a surface profile of a side of the eye cup 50 facing the inner surface 11 at least partially corresponds to a surface profile of the inner surface 11, and the eye cup 50 is flexible and is made of an elastic material (such as silicone) so that the eye cup 50 can be closely attached with the inner surface 11 and is comfortable to wear.

The eye cup 50 includes an attaching portion 52 and a shielding portion 53, a side of the attaching portion 52 facing the inner surface 11 has the at least one second magnetic member 30 disposed thereon, and the shielding portion 53 extends from the attaching portion 52 in a direction remote from the at least one second magnetic member 30. A diametrical dimension of each said second magnetic member 30 corresponds to a diametrical dimension of one said first magnetic member 20 so as to effectively attract with one another.

Preferably, the shielding portion 53 includes two shields 531 corresponding to the two said eye rims 13, and each of the two shields 531 circumferentially surrounds one of the two said eye rims 13, which can effectively block a user's eyes from dust and wind. The frame 10 defines a central axis C, based on the attaching portion 52, a width of each of the two shields 531 is gradually increased in a direction remote from the central axis C so as to entirely surround the user's orbital sockets and greatly reduce a gap between the user's face and the eye cup 50. A side of each of the two shields 531 remote from the attaching portion 52 preferably has an arcuate abutting edge 531a bended inward for comfortable wearing. In other embodiments, the frame may be formed with only one said eye rim for a pair of uni-lens glasses, and the shielding portion may include one said shield corresponding to the said eye rim.

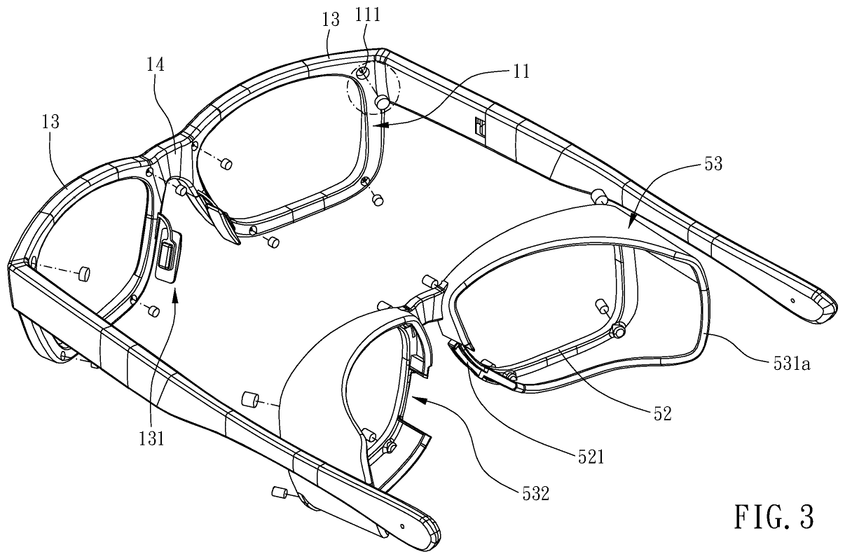

Each of the two said eye rims 13 has a nose supporter 131 disposed thereon, and each of the two shields 531 includes a notch 532 corresponding to one said nose supporter 131. In a circumferential direction of one of the two said eye rims 13, a width of each said notch 532 is smaller than or equal to a width of one said nose supporter 131, as shown in FIGS. 3 and 5. Therefore, gaps between the frame 10 and the eye cup 50 are greatly decreased to provide good windproof effect. Furthermore, each said nose supporter 131 includes a pad arm 132 and a nose pad 133 connected to the pad arm 132, and an outer surface of each of the two shields 531 has a dodge slot 533 communicated with one said notch 532. The attaching portion 52 further includes two stepped portions 521 respectively corresponding to one said notch 532. When each said pad arm 132 is located within one said dodge slot 533 and each said nose pad 133 corresponds to one said notch 532, each of the two stepped portions 521 is located between one said nose pad 133 and the inner surface 11, which provides positioning effect and reduces the gaps between the frame 10 and the eye cup 50.

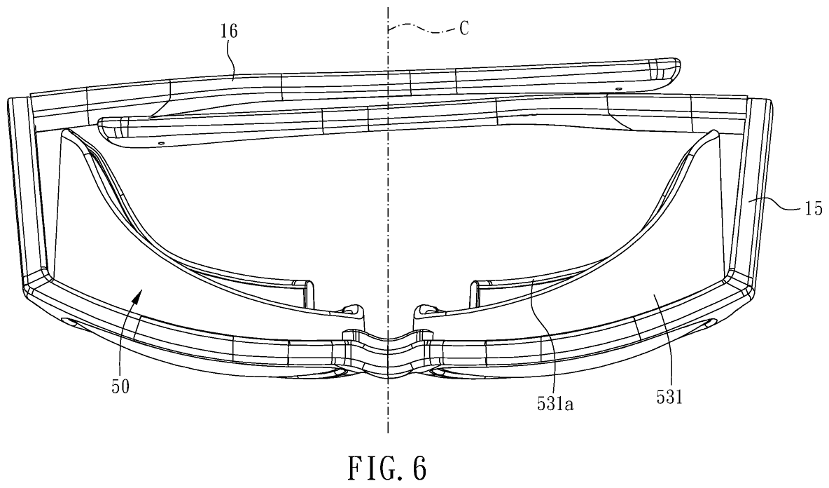

Please refer to FIG. 6, each of the two connecting portions 15 is not in contact with the eye cup 50, which avoids unexpected movement during wearing. An end of each of the two connecting portions 15 has a pivot structure 151 disposed thereon. As viewed in a direction lateral to the central axis C, the eye cup 50 does not protrude beyond the pivot structure 151 of each of the two connecting portions 15 so that the two temples 16 are foldable without deformation of the eye cup 50, which is convenient to use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A pair of glasses, including:
a frame, including an inner surface and an outer surface opposite to each other, the inner surface having at least one first receiving groove disposed thereon and including at least one projection located within the at least one first receiving groove; and
at least one first magnetic member, configured to be attached with at least one second magnetic member by a magnetic attractive force, including at least one recession disposed thereon, the at least one first magnetic member received within the at least one first receiving groove and the at least one projection received within the at least one recession.

2. The pair of glasses of claim 1, wherein each said first magnetic member and a groove wall of one said first receiving groove have an adhesive material disposed therebetween, and a portion of the adhesive material is disposed between one said first magnetic member and one said projection.

3. The pair of glasses of claim 1, wherein each said first magnetic member is tightly fit into one said first receiving groove and engaged with one said projection via one said recession in tight fit.

4. The pair of glasses of claim 1, wherein in a depth direction of the at least one first receiving groove, each said projection protrudes from a bottom wall of one said first receiving groove along the depth direction.

5. The pair of glasses of claim 1, wherein each said projection is a column, and each said recession is a through hole penetrating through one said first magnetic member.

6. The pair of glasses of claim 1, wherein each said projection is a column, and each said recession is a blind hole extending in a thickness direction of one said first magnetic member

7. The pair of glasses of claim 1, wherein each said projection is a column extending along a central axis of one said first receiving groove.

8. The pair of glasses of claim 1, wherein the frame further includes at least one eye rim configured to be assembled with at least one lens, the at least one eye rim has a plurality of said first receiving grooves and a plurality of said first magnetic members disposed thereon, and the plurality of said first receiving grooves are spaced apart from one another and circumferentially arranged.

9. The pair of glasses of claim 1, further including an eye cup detachably connected to the inner surface, wherein the eye cup has the at least one second magnetic member disposed thereon, and a number of the at least one second magnetic member corresponds to a number of the at least one first magnetic member.

10. The pair of glasses of claim 9, wherein the eye cup includes an attaching portion and a shielding portion, a side of the attaching portion facing the inner surface has the at least one second magnetic member disposed thereon, and the shielding portion extends from the attaching portion in a direction remote from the at least one second magnetic member.

11. The pair of glasses of claim 9, wherein the frame further includes two connecting portions configured to be assembled with two temples, and each of the two connecting portions is not in contact with the eye cup.

12. The pair of glasses of claim 9, wherein the frame defines a central axis and further includes two connecting portions configured to be assembled with two temples, an end of each of the two connecting portions has a pivot structure disposed thereon; and as viewed in a direction lateral to the central axis, the eye cup does not protrude beyond the pivot structure of each of the two connecting portions.

13. The pair of glasses of claim 9, wherein a surface profile of a side of the eye cup facing the inner surface at least partially corresponds to a surface profile of the inner surface, the eye cup is flexible and is made of an elastic material, and the eye cup includes at least one second receiving groove received the at least one second magnetic member therewithin.

14. The pair of glasses of claim 10, wherein each said first magnetic member and a groove wall of one said first receiving groove have an adhesive material disposed therebetween, and a portion of the adhesive material is disposed between one said first magnetic member and one said projection; in a depth direction of the at least one first receiving groove, each said projection protrudes from a bottom wall of one said first receiving groove along the depth direction; each said first receiving groove is a circular groove, and each said projection is a column extending along a central axis of one said first receiving groove; the frame further includes two eye rims configured to be assembled with two lenses, the shielding portion includes two shields corresponding to the two eye rims, and each of the two shields circumferentially surrounds one of the two eye rims; each of the two eye rims has a nose supporter disposed thereon, each of the two shields includes a notch corresponding to one said nose supporter, and in a circumferential direction of one of the two eye rims, a width of each said notch is smaller than or equal to a width of one said nose supporter; each of the two eye rims has a plurality of said first receiving grooves and a plurality of said first magnetic members disposed thereon, the plurality of said first receiving grooves are spaced apart from one another and circumferentially arranged; the frame further includes two connecting portions configured to be assembled with two temples, and each of the two connecting portions is not in contact with the eye cup; the frame further includes a nose bridge connected between the two eye rims, a diametrical dimension of one of said first magnetic members adjacent to one of the two connecting portions is larger than a diametrical dimension of one of said first magnetic members adjacent to the nose bridge; the frame defines a central axis, an end of each of the two connecting portions has a pivot structure disposed thereon; and as viewed in a direction lateral to the central axis, the eye cup does not protrude beyond the pivot structure of each of the two connecting portions; a surface profile of a side of the eye cup facing the inner surface at least partially corresponds to a surface profile of the inner surface, the eye cup is flexible and is made of an elastic material, and the eye cup includes at least one second receiving groove received the at least one second magnetic member therewithin; a diametrical dimension of each said second magnetic member corresponds to a diametrical dimension of one said first magnetic member; based on the attaching portion, a width of each of the two shields is gradually increased in a direction remote from the central axis; a side of each of the two shields remote from the attaching portion has an arcuate abutting edge bended inward; each said nose supporter includes a pad arm and a nose pad connected to the pad arm, an outer surface of each of the two shields has a dodge slot communicated with one said notch, and the attaching portion further includes two stepped portions respectively corresponding to one said notch; and when each said pad arm is located within one said dodge slot and each said nose pad corresponds to one said notch, each of the two stepped portions is located between one said nose pad and the inner surface.
